(19) United States
(12) Patent Application Publication
(10) Pub. No.: US 2025/0219913 A1
(43) Pub. Date: Jul. 3, 2025

(54) NETWORK AS A SERVICE FOR CONTROLLING QUALITY ON DEMAND USING AN APPLICATION PROGRAMMING INTERFACE

(71) Applicant: T-MOBILE INNOVATIONS LLC, Overland Park, KS (US)

(72) Inventors: Ravikumar SUBRAMANIAN, Bothell, WA (US); Poornima MAGADEVAN, Renton, WA (US); Suryanarayana Murthy GORTY, Redmond, WA (US); Suresh THANNEERU, Bothell, WA (US); Chandrasekhar DARISI, Bothell, WA (US); Paria HAKIMI, Franklin, TN (US)

(21) Appl. No.: 18/403,260

(22) Filed: Jan. 3, 2024

(51) Int. Cl. H04L 41/5019; G06F 9/54

(52) U.S. Cl. CPC H04L 41/5019; G06F 9/547

(57) ABSTRACT

Methods and systems for providing mobile broadband services to high speed rail are provided. The method begins with receiving, at an application programming interface (API) module on the network, a request from a user device. The request comprises a request payload that comprises a quality on demand (QoD) metric to be used in the NaaS operations. The QoD metric may be selected to provide for a desired level or service or operating quality that a developer wishes to provide. The request payload is then processed at the API module, wherein the processing determines if the network supports the QoD metric being requested. After processing, a response is transmitted from the API module to the user device, wherein the response comprises a response payload responsive to the QoD metric in the request payload.

### BACKGROUND

Network-as-a-service (NaaS) enables users to operate a network without building and maintaining a communications network. NaaS allows businesses, users, and other organizations to utilize communication network architecture through flexible operating subscriptions that may include software, hardware, management tools, licenses, and lifecycle services. Quality on demand (QoD) allows a mobile user to request an improved connection, for example, better latency or better bandwidth. Allowing developers to access the network requires an application programming interface (API) that allows developers to access network functions and also to control the communication network on demand.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for providing NaaS services through an API are provided. The method begins with receiving, at an API module on the network, a request from a user device. The request comprises a request payload that comprises a QoD metric to be used in the NaaS operations. The QoD metric may be selected to provide for a desired level or service or operating quality that a developer wishes to provide to those using the application or service the developer is creating. The request payload is then processed at the API module, wherein the processing determines if the network supports the QoD metric being requested. After processing, a response is transmitted from the API module to the user device, wherein the response comprises a response payload responsive to the QoD metric in the request payload.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a network architecture for use with an API to allow QoD in NaaS operation, in accordance with aspects herein;

FIG. 4 depicts a flow diagram of an exemplary method for using an API to provide QoD on demand in NaaS operations, in accordance with aspects herein; and

FIG. 5 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure.

NaaS allows users to operate a network without building and maintaining a complete network infrastructure. This service may be provided through an API that allows developers to access the network to further develop applications that will provide the NaaS services. The API may also offer developers the ability to offer QoD services that provide UEs accessing the NaaS services with a desired quality of service (QOS). QoD provides benefits to network users, specifically the ability to request a QoD session that provides improved bandwidth and/or latency, a desirable option for applications such as gaming, augmented reality (AR), virtual reality (VR), as well as autonomous device operation. The QoD session may be based on a session identifier. The QoD session may also be terminated using the session identifier.

Embodiments described herein provide a method for providing quality on demand (QoD) in NaaS operations. The method begins with receiving, at an API on the network a request from a user device. The request from the user device comprises a request payload that comprises a QoD that the user device intends the NaaS operation to use. After processing, the API module transmits a response to the user device, with the response comprising a response payload responsive to the QoD metric in the request payload.

Further, various technical terms are used throughout this description. An illustrative resource that fleshes out various aspects of these terms can be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of access points (i.e., access point, node, cell sites, cell towers) to provide network coverage. The access points are employed to broadcast and transmit transmissions to user devices of the telecommunications network. An access point may be considered to be a portion of an access point that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, an access point may comprise one access point or more than one access point. Factors that can affect the telecommunications transmission include, e.g., location and size of the access points, and frequency of the transmission, among other factors. The access points are employed to broadcast and transmit transmissions to user devices of the telecommunications network. Traditionally, the access point establishes uplink (or downlink) transmission with a mobile handset over a single frequency that is exclusive to that particular uplink connection (e.g., an LTE connection with an EnodeB). The access point may include one or more sectors served by individual transmitting/receiving components associated with the access point (e.g., antenna arrays controlled by an EnodeB). These transmitting/receiving components together form a multi-sector broadcast arc for communication with mobile handsets linked to the access point.

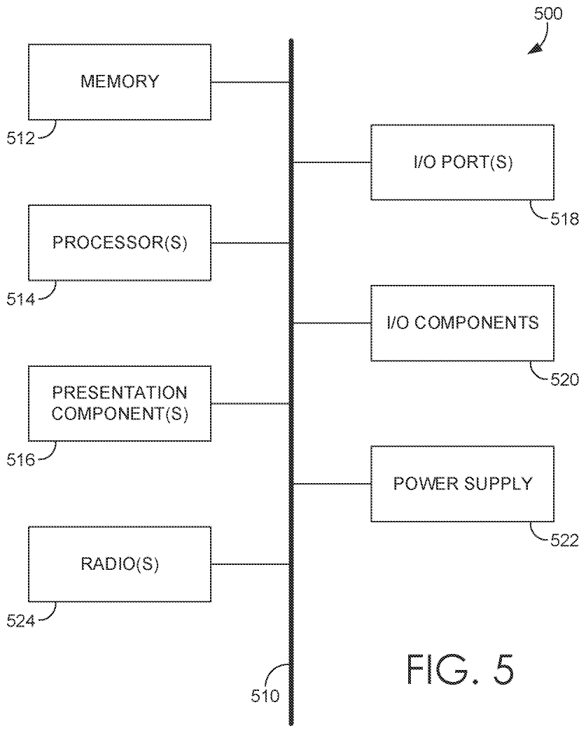

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point. A UE may be, in an embodiment, similar to device 500 described herein with respect to FIG. 5.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

A first aspect of the present disclosure provides a method for using an API to provide QoD on demand in NaaS operations. The method begins with receiving, at an API module on the network, a request from a user device. The user device is used by a developer who is planning to offer NaaS services. The request comprises a request payload that comprises a QoD metric that is to be used in the NaaS operation. The method then continues with processing the request payload, wherein the processing determines if the network supports the QoD metric. The method then concludes with transmitting a response from the API to the user device, wherein the response comprises a response payload responsive to the QoD metric in the request payload.

A second aspect of the present disclosure provide a method for providing QoD in NaaS operations in a network. The method begins with transmitting a request from a user device to an API. The request may be from a developer using the user device to plan for NaaS operations. The response payload comprises a QoD metric that the developer intends to use in NaaS operations. The method concludes with receiving a response from the API module at the user device, wherein the response comprises a response payload that is responsive to the QoD metric in the request payload.

Another aspect of the present disclosure is directed to a non-transitory computer storage media storing computer-usable instructions that cause the processors to receive, at an API, a request, wherein the request comprises a request payload that comprises a QoD metric to be used in the NaaS operation. The instructions then process the request payload at the API module. The instructions conclude when a response from the API module is sent to the user device, wherein the response comprises a response payload that is responsive to the QoD metric in the request payload.

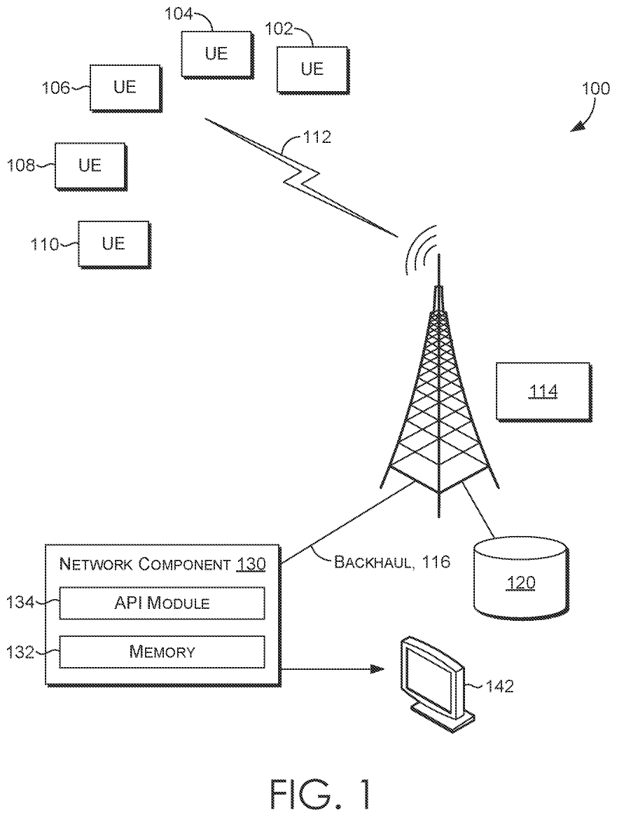

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user devices (UE) 102, 104, 106, 108, and 110, access point 114 (which may be a cell site, access point, or the like), and one or more communication channels 112. The communication channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 500) that communicates via wireless communications with the access point 114 in order to interact with a public or private network.

In some aspects, each of the UEs 102, 104, 106, 108, and 110 may correspond to computing device 500 in FIG. 5. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network. In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114.

The network environment 100 may be comprised of a telecommunications network(s), or a portion thereof. A telecommunications network might include an array of devices or components (e.g., one or more access points), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure. Network environment 100 may comprise equipment placed in network operator facilities, but may also comprise equipment located at a customer's premises, known as customer premises equipment (CPE).

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G, and the like) to user devices, such as UEs 102, 104, 106, 108, and 110. For example, the one or more communication channels 112 may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network or a 6G network. The telecommunication network may also provide services using MU-MIMO techniques.

In some implementations, access point 114 is configured to communicate with a UE, such as UEs 102, 104, 106, 108, and 110, that are located within the geographic area, or cell, covered by radio antennas of access point 114. Access point 114 may include one or more access points, base transmitter stations, radios, antennas, antenna arrays, power amplifiers, transmitters/receivers, digital signal processors, control electronics, GPS equipment, and the like.

As shown, access point 114 is in communication with a network component 130 and at least a network database 120 via a backhaul channel 116. A computer terminal 142 may be in communication with the network through network component 130 and through the network component 130 and the backhaul 116 to access point 114. As the UEs 102, 104, 106, 108, and 110 collect individual signal information, the signal information can be automatically communicated by each of the UEs 102, 104, 106, 108, and 110 to the access point 114. Access point 114 may store the signal information and data communicated by the UEs 102, 104, 106, 108, and 110 at a network database 120. The signal information may comprise information on QoD parameters such as latency or bandwidth requested. Alternatively, the access point 114 may automatically retrieve the status data from the UEs 102, 104, 106, 108, and 110, and similarly store the data in the network database 120. The signal information and data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132 and an API module 134. All determinations, calculations, and data further generated by the API module 134 may be stored at the memory 132 and also at the data store 120. Although the network component 130 is shown as a single component comprising the memory 132, API module, and the data store 140, it is also contemplated that each of the memory 132 and the API module 136 may reside at different locations, be its own separate entity, and the like, within the home network carrier system.

The API module 134 allows application developers to provide NaaS and communications platform as a service (CPaaS). The API module 134 provides a set of defined rules that allow developers to access the network as part of developing new applications and offerings. The API module 134 also acts as an intermediary layer for data processing between systems. Specifically, the API module 134 opens the wireless communication network to third-party application developers and provides the interface for communication between the network and the application.

CPaaS is a cloud based delivery model that allows businesses or other organization to add real-time communications capabilities such as voice, video and messaging to the applications through the API module 134. The communication services may be embedded into applications to provide additional services such as click to call.

The network component 130 is configured to retrieve signal quality metrics, QoD metrics, and carrier loading metrics from the access point 114 or one of the UEs, 102, 104, 106, 108, and 110. Signal quality metrics can include any one or more of multiple metrics, such as signal-to-interference and noise (SINR), reference signal received power (RSRP), and reference signal received quality (RSRQ). QoD metrics can include information on the QoS requested by each UE and application as well as traffic information. The network component 130 can also track uplink and downlink user traffic. The API module 134 can observe data usage the network for multiple applications using NaaS and CPaaS services. The API module 134 may each be located in a central office or other centralized location, but may also be mounted on an access point for use in an edge computing application. The API module 134, acting in conjunction with the memory 132 may ensure that the UEs 102, 104, 106, 108, and 110, operate in conjunction with developers to provide third-party application services.

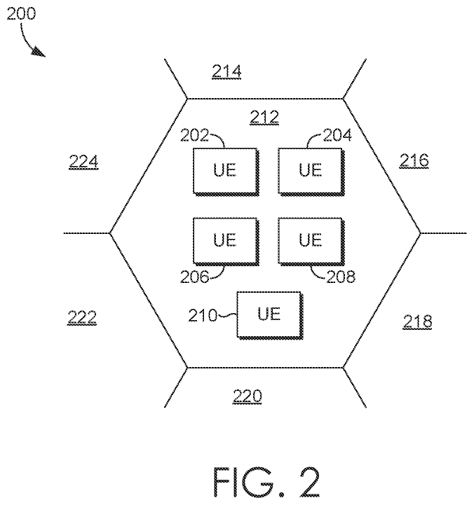

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including access point 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell site 212 and can move to other cells such as adjoining cell sites 214, 216, 218, 220, 222 and 224.

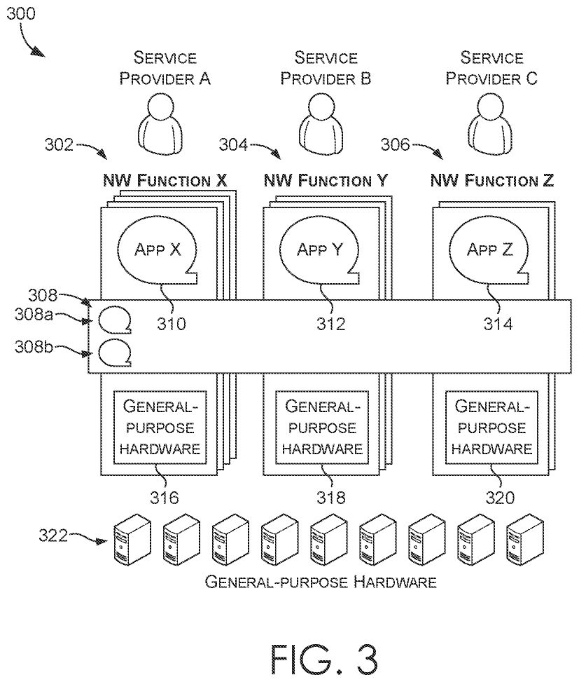

FIG. 3 depicts a network architecture for use with an API to allow QoD in NaaS operation, in accordance with aspects herein. A network 300 may provide multiple network functions as part of NaaS using an API. The network functions may include a first network function X 302, a second network function Y 304, and a third network function Z 306. The network 300 may provide additional network functions that may be accessed through the API. A common network server platform 308 allows optimizing reliability, scalability, and management for the network services. The common network server platform 308 may provide functionality for scalability function 308 A and functionality for reliability function 308 B. A first application X 310, a second application Y 312, and a third application Z 314 may access network functions through the common network server platform 308. Each network function X 302, Y 304, and Z 306 may also operate in conjunction with general purpose hardware associated with the network functions. Thus, first network function X 302 uses associated first general purpose hardware 316, second network function Y 304 uses associated second general purpose hardware 318, and third network function Z 306 uses associated third general purpose hardware 320. The network 300 may have general purpose hardware 322 to further support network operations.

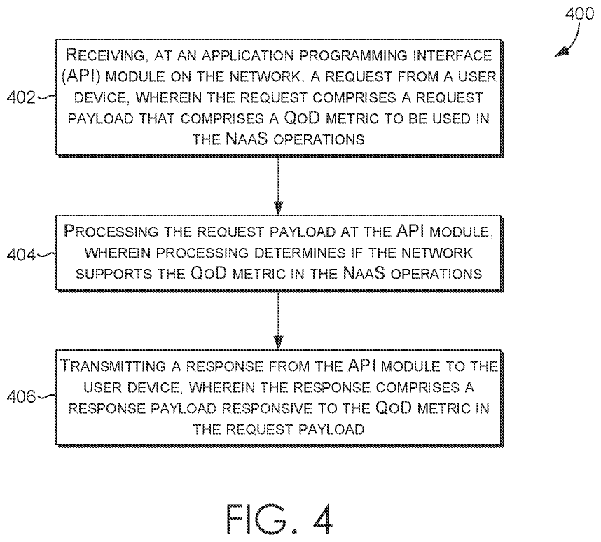

FIG. 4 depicts a flow diagram of an exemplary method for cellular service for high speed rail in a network, in accordance with aspects herein. The method 400 begins in step 402 with receiving, at an API module on the network, a request from a user device, wherein the request comprises a request payload that comprises a QoD metric to be used in the NaaS operation. The user device may be used by a developer planning to offer QoD services as part of a NaaS operation. The Naas operation may be a website for a business that wants to provide enhanced latency times for customers calling the business, to give just one example. The method continues in step 404 with processing the request payload at the API module, wherein processing determines if the network supports the QoD metric. Once the processing has determined if the network supports the QoD metric the method continues in step 404 with transmitting a request from the API to the user device, wherein the response comprises a response payload responsive to the QoD metric in the request payload.

The QoD metric in the request may be selected by the developer programming an application for NaaS services. The processing determines if the requested QoD can be supported by the network. Support for QoD metrics may vary depending on the type of NaaS services. In some situations, the network may not be able to support the QoD metric requested by the developer and the response may indicate if the requested QoD can be supported. If the QoD requested cannot be supported, the network may respond with a supported QoD or may response with a range of QoDs that are supported.

FIG. 5 depicts an exemplary computing device suitable for use in implementations of the present disclosure, in accordance with aspects herein. With continued reference to FIG. 5, computing device 500 includes bus 510 that directly or indirectly couples the following devices: memory 512, one or more processors 514, one or more presentation components 516, input/output (I/O) ports 518, I/O components 520, radio(s) 524, and power supply 522. Bus 510 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. Memory 512 may be removable, nonremovable, or a combination thereof. Exemplary memory includes solid-state memory, hard drives, optical-disc drives, etc. Computing device 500 includes one or more processors 606 that read data from various entities such as bus 510, memory 512 or I/O components 520. One or more presentation components 516 present data indications to a person or other device. Exemplary one or more presentation components 516 include a display device, speaker, printing component, vibrating component, etc. I/O ports 518 allow computing device 500 to be logically coupled to other devices including I/O components 520, some of which may be built into computing device 500. Illustrative I/O components 520 include a microphone, joystick, game pad, satellite dish, scanner, printer, wireless device, etc.

The radio(s) 524 represents one or more radios that facilitate communication with a wireless telecommunications network. While a single radio 524 is shown in FIG. 5, it is contemplated that there may be more than one radio 524 coupled to the bus 510. Illustrative wireless telecommunications technologies include CDMA, GPRS, TDMA, GSM, and the like. The radio 524 may additionally or alternatively facilitate other types of wireless communications including Wi-Fi, WiMAX, LTE, 3G, 4G, LTE, 5G, NR, VOLTE, or other VOIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a access point, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for providing quality on demand (QoD) in network as a service (NaaS) operations in a network, the method comprising:
receiving, at an application programming interface (API) module on the network, a request from a user device, wherein the request comprises a request payload that comprises a QoD metric to be used in the NaaS operations;
processing the request payload at the API module, wherein processing determines if the network supports the QoD metric in the NaaS operations; and
transmitting a response from the API module to the user device, wherein the response comprises a response payload responsive to the QoD metric in the request payload.

2. The method of claim 1, wherein the QoD metric is a latency metric.

3. The method of claim 1, wherein the QoD metric is a bandwidth metric.

4. The method of claim 1, wherein the request payload comprises at least one network service for which the QoD metric is requested.

5. The method of claim 4, wherein the at least one network service comprises video services.

6. The method of claim 5, wherein the at least one network service comprises video services supporting a third-party gaming application.

7. The method of claim 1, wherein the at least one network service comprises video services supporting a third-party augmented reality (AR) application.

8. The method of claim 1, wherein the at least one network service comprises real-time data services supporting third-party autonomous device operations.

9. A method for providing quality on demand (QoD) in network as a service (NaaS) operations in a network, the method comprising:
transmitting a request from a user device to an application programming interface (API) module, wherein the request comprises a request payload that comprises a QoD metric to be used in NaaS operation; and
receiving a response from the API module at the user device, wherein the response comprises a response payload responsive to the QoD metric in the request payload.

10. The method of claim 9, wherein the QoD metric is a latency metric.

11. The method of claim 9, wherein the QoD metric is a bandwidth metric.

12. The method of claim 9, wherein the request payload comprises at least one network service for which the QoD metric is requested.

13. The method of claim 12, wherein the at least one network service comprises video services.

14. The method of claim 13, wherein the at least one network service comprises video servers supporting a third-party gaming application.

15. The method of claim 9, wherein the at least one network service comprises video services supporting a third-party augmented reality (AR) application.

16. The method of claim 9, wherein the at least one network service comprises real-time data services supporting third-party autonomous device operations.

17. A non-transitory computer storage media storing computer-usable instructions that, when used by one or more processors, cause the processor to:
receive, at an application programming interface (API) module on the network, a request from a user device, wherein the request comprises a request payload the comprises a QoD metric to be used in the NaaS operations;
process the request payload at the API module, wherein processing determines if the network supports the QoD metric; and
transmit a response from the API module to the user device, wherein the response comprises a response payload responsive to the QoD metric in the request payload.

18. The non-transitory computer storage media of claim 17, wherein the QoD metric is a latency metric.

19. The non-transitory computer storage media of claim 17, wherein the QoD metric is a bandwidth metric.

20. The non-transitory computer storage media of claim 17, wherein the request payload comprises at least one network service for which the QoD metric is requested.
